(19) United States
(12) Patent Application Publication
(10) Pub. No.: US 2012/0171340 A1
(43) Pub. Date: Jul. 5, 2012

(54) Energy Charged Alcoholic Beverages for Enhancing the Alternative Cellular Energy (ACE) Pathway in the Prevention and Therapy of Diseases

(76) Inventor: William John Martin, (US)

(21) Appl. No.: 12/984,582

(22) Filed: Jan. 4, 2011

(51) Int. Cl. C12C 12/00; G01N 21/64

(52) U.S. Cl. 426/248; 250/459.1; 426/237

(57) ABSTRACT

The alternative cellular energy (ACE) pathway provides a non-immunological defense mechanism against infectious diseases and can also function as an effective tissue repair mechanism in response to injury. The ACE pathway can be activated using energy obtained from the ultraviolet light illumination of neutral red dissolved in alcohol. The effectiveness of the alcohol used in this procedure has previously been shown to increase if the alcohol is “charged” by passing electrolytically generated “Water Gas” (otherwise referred to as Brown's Gas or HHO) into the alcohol. Water Gas is herein shown to be similarly able to charge alcoholic beverages, including beer, wines and spirits, resulting in an increase in the ability of the alcoholic beverages to dynamically interact with dyes, such as neutral red, and by inference to be more effective, than the corresponding uncharged alcoholic beverage, in therapeutic uses intended to enhance the ACE pathway of an individual.

### CROSS REFERENCE TO RELATED APPLICATIONS

Co-Pending Patent Application

Methods for Detection of Ultraviolet Light Reactive Alternative Cellular Energy Pigments (ACE-pigments) William John Martin Submitted Dec. 24, 2007. Publication number 20090163831

Method of assessing and of activating the alternative cellular energy (ACE) pathway in the Therapy of Diseases. William John Martin Submitted Submitted Jan. 16, 2008. Publication number 20090181467

Enerceutical mediated activation of the alternative cellular energy (ACE) pathway in the therapy of diseases. Submitted May 8, 2008. Publication number 20090280193

Enerceutical activation of the alternative cellular energy (ACE) pathway in therapy of diseases. Submitted Feb. 11, 2009. Publication number 20090202442

Method of using the body's alternative cellular energy pigments (ACE-pigments) in the therapy of diseases Submitted Feb. 20, 2009. Publication number 20100215763

Urine as a source of alternative cellular energy pigments (ACE-pigments) in the assessment and therapy of diseases. Submitted Mar. 5, 2009. Publication number 20100196297

Diagnostic value of systemic ACE pathway activation in the detection by fluorescence of localized pathological lesions. Submitted Jul. 26, 2010. Publication number 20100291000

Enerceutical mediated activation of the alternative cellular energy (ACE) pathway in the therapy of diseases. Submitted July 2010.

Energy Charged Liquids to Enhance Enerceutical Activation of the Alternative Cellular

Energy (ACE) Pathway in the Therapy of Diseases. Submitted Dec. 17, 2010

Other Relevant Patents and Patent Applications by William John Martin: Stealth viruses nucleic acids and related methods. U.S. Pat. No. 5,703,221. Issued Dec. 30, 1997.

Isolated stealth viruses and related vaccines. U.S. Pat. No. 5,753,488. Issued May 19, 1998.

Stealth virus detection in the chronic fatigue syndrome. U.S. Pat. No. 5,985,546. Issued May 26, 1998.

Stealth virus detection in the chronic fatigue syndrome. U.S. Pat. No. 5,985,546. Issued Nov. 16, 1999.

Method of generating hydrogen in gasoline using an enerceutical product added to magnesium in a hydrogen permeable but solute impermeable container. Submitted Jul. 18, 2008. Publication number 20100011657

Method of generating hydrogen and of selectively transferring the generated hydrogen to drinking water as a potential source of alternative cellular energy (ACE). Submitted Jul. 9, 2008. Publication number 20100008849

Method of generating hydrogen in drinking water using an enerceutical product added to magnesium in a hydrogen permeable but solute impermeable container. Submitted Jul. 14, 2008. Publication number 20100008850

Martin W J, Palmer S B. Regenerative wound healing using copper-silver citrate composition. Submitted Oct. 22, 2008. Publication number 20100099758 Apr. 22, 2010.

Patents and Patent Applications Relevant to the Present Application by Other Inventors:

Water Gas (Also called Brown's Gas and HHO)

William Rhodes et al Apparatus for the electrolytic production of hydrogen and oxygen for the safe combustion thereof Patent number US003262872 Issued Jul. 26, 1966

Horvath; Stephen. Fuel supply apparatus for internal combustion engines. U.S. Pat. No. 3,980,053. Issued Sep. 14, 1976.

Brown, Yull. Welding. U.S. Pat. No. 4,014,777 Issued Mar. 29, 1977.

Brown, Yull Arc-assisted oxy/hydrogen welding U.S. Pat. No. 4,081,656. Issued Mar. 28, 1978.

Inoue, Kiyoshi. Method of electrolytically generating hydrogen and oxygen for use in a torch or the like. U.S. Pat. No. 4,184,931 Issued Jan. 22, 1980.

McCambridge, Michael Electrolysis Of Water. U.S. Pat. No. 4,726,888 issued Feb. 23, 1988

Willey, Alan P. Radford, Neal T. Apparatus for gas generation. U.S. Pat. No. 5,082,544. Issued Jan. 21, 1992.

Chiang ,Huang C. Apparatus for generating a mixture of hydrogen and oxygen for producing a hot flame. U.S. Pat. No. 5,244,558 Issued Sep. 14, 1993.

Oshima, Yujiro Hydrogen Generator. Patent number 5,401,371. Issued Mar. 29, 1995

Stowe, Gene B. Hydrogen/Oxygen Fuel Cell. Patent number 5,231,954 Issued Aug. 3, 1995.

Shiramizu, Yoshimi, Nakamori, Masaharu, Aoki, Hidemitsu, Seo, Hirofumi, Hamano; Ross, Bill. Internal combustion engine kit with electrolysis cell. U.S. Pat. No. 6,209,493. Issued Apr. 3, 2001.

Klein; Dennis. Hydrogen generator for uses in a vehicle fuel system. U.S. Pat. No. 6,866,756. Issued Mar. 15, 2005.

Holt, Cecil G, Baker, Toby D, Speight, John Leland, Anderson Iboynne M, Salmon, Jeff, Stevens, David. Water fuel convertor. U.S. Pat. No. 7,261,062. Issued Aug. 28, 2007.

Klein, Dennis J. Santilli, Ruggero Maria; Apparatus and method for the conversion of water into a new gaseous and combustible form and the combustible gas formed thereby. Patent application number 20040149591. Published Aug. 5, 2004.

Klein; Dennis. Apparatus and method for the conversion of water into a clean burning combustible gas for use as an additive with other forms of fuels. Patent application number 20070151846. Published Jul. 5, 2007.

Kang, Song Doug. Use of brown's gas and feeding apparatus of the brown's gas. Patent application number 20070104797. Published May 10, 2007.

Heath; Kevin; Gardner; Barry; Lang; Bill; Lang; Tom. System and method for improving fuel economy in combustion engines. Patent application number 20100147232. Published Jun. 17, 2010.

Kang, Song Doug. Method of treating or alleviating the symptoms of a lesion in mammal. Patent application number 20100173008 Published Jul. 8, 2010

Dees, James D, Colclesser, Ken. Hydrogen generator designed for use with gas and diesel engines. Patent application number 20100282600. Published Nov. 11, 2010.

Haruto. Method for producing electrolyzed water 5,543,030 Issued Aug. 6, 1996.

Electrolyzed Water Used as Therapy

Shimamune, Takayuki, Tanaka, Masashi, Nakajima, Yasuo, Nishiki, Yoshinori, Shimizu, Hideto. Production method of acid water and alkaline water. 6,527,940. Issued Mar. 4, 2003.

Norton, Verdis, Samuelson, Gary L. Method and apparatus for producing a stabilized antimicrobial non-toxic electrolyzed saline solution exhibiting potential as a therapeutic. Patent application number 20090110749. Published Apr. 30, 2009.

Chen, Ho-Hsien, Huang, Tzou-Chi, Huang, Hao-Hsun, Tung, Jung-Chang. Method for generating high concentration chlorine dioxide by means of electrolysis. Patent application number 20080308428. Published Dec. 18, 2008

Fukai, Toshiharu. Water Having Anticancer Activity and Method for Making the Same. Patent application number 20100233071. Publishe Sep. 16, 2010

Electrolyzer cell for producing acidic or alkaline water. Patent application number 20100270172. Published Oct. 28, 2010

Haase, Steven, Haase; Sherry, Holle, Greg, Holle, Tamera. Ionic foot bath array. Patent application number 20090069870. Published Mar. 12, 2009.

References to Published Articles Relevant to the Present Patent Application Alternative Cellular Energy Pigments (ACE-pigments):

1 Martin W J. Alternative cellular energy pigments mistaken for parasitic skin infestations. Exp. Mol. Path 78: 212-214, 2005.

2 Martin W J. Alternative cellular energy pigments from bacteria of stealth virus infected individuals. Exp. Mol. Path 78: 217-217, 2005.

3 Martin W J. Progressive Medicine. Exp Mol Path 78: 218-220, 2005.

4 Martin W J , Stoneburner J. Symptomatic relief of herpetic skin lesions utilizing an energy based approach to healing. Exp. Mol. Path 78: 131-4, 2005.

5 Martin W J. Etheric Biology. Exp Mol Path 78: 221-227, 2005.

6 Martin W J. Stealth Virus Culture Pigments: A Potential Source of Cellular Energy. Exp. Mol. Pathol. . 74: 210-223, 2003.

7 Martin W J. Complex intracellular inclusions in the brain of a child with a stealth virus encephalopathy. Exp. Mol. Pathol. 74: 179-209, 2003.

8 Martin W J. Photons and phonons: Theoretical aspects of biophysics and potential therapeutic applications. Proceeding of Neural Therapy Workshop on Sound and Light Therapy, Seattle, Wash., Feb. 21-23, 2003.

Stealth Adapted Viruses

1 Martin W J Chronic fatigue syndrome among physicians. A potential result of occupational exposure to stealth viruses. Explore 2001; 10: 7-10.

2 Martin W J. Stealth Viruses. Explore 2001; 10: 17-19.

3 Durie G M, Collins R. Martin W J. Positive stealth virus cultures in multiple myeloma. A possible explanation for neuropsychiatric co-morbidity. Presented at the Am. Soc. Hematology annual meeting October 2000.

4 Martin W J. Chemokine receptor-related genetic sequences in an African green monkey simian cytomegalovirus-derived stealth virus. Exp Mol Pathol. 2000; 69:10-6.

5 Martin W J., Anderson D. Stealth virus epidemic in the Mohave Valley: severe vacuolating encephalopathy in a child presenting with a behavioral disorder. Exp Mol Pathol. 1999; 66:19-30.

6 Martin W J. Melanoma growth stimulatory activity (MGSA/GRO-alpha) chemokine genes incorporated into an African green monkey simian cytomegalovirus-derived stealth virus. Exp Mol Pathol. 1999; 66:15-8.

7 Martin W J. Bacteria-related sequences in a simian cytomegalovirus-derived stealth virus culture. Exp Mol Pathol. 1999; 66:8-14.

8 Martin W J. Stealth adaptation of an African green monkey simian cytomegalovirus. Exp Mol Pathol. 1999; 66:3-7.

9 Martin W J. Cellular sequences in stealth viruses. Pathobiology 1998; 66:53-8.

10 Martin W J. Detection of RNA sequences in cultures of a stealth virus isolated from the cerebrospinal fluid of a health care worker with chronic fatigue syndrome. Case report. Pathobiology. 1997; 65:57-60.

11 Martin W J., Anderson D. Stealth virus epidemic in the Mohave Valley. I. Initial report of virus isolation. Pathobiology. 1997; 65:51-6.

12 Martin W J. Simian cytomegalovirus-related stealth virus isolated from the cerebrospinal fluid of a patient with bipolar psychosis and acute encephalopathy. Pathobiology. 1996; 64:64-6.

13 Martin W J. Stealth viral encephalopathy: report of a fatal case complicated by cerebral vasculitis. Pathobiology. 1996; 64:59-63.

14 Martin W J. Genetic instability and fragmentation of a stealth viral genome. Pathobiology. 1996; 64:9-17.

15 Martin W J. Severe stealth virus encephalopathy following chronic-fatigue-syndrome-like illness: clinical and histopathological features. Pathobiology. 1996; 64:1-8.

16 Martin W J. Stealth virus isolated from an autistic child. J Autism Dev Disord. 1995; 25 :223-4.

17 Gollard R P, Mayr A., Rice D A, Martin W J. Herpesvirus-related sequences in salivary gland tumors. J Exp Clin Cancer Res., 1996; 15: 1-4.

18 Martin W J., Glass R T. Acute encephalopathy induced in cats with a stealth virus isolated from a patient with chronic fatigue syndrome. Pathobiology. 1995; 63:115-8.

19 Martin W J, et al. African green monkey origin of the atypical cytopathic ‘stealth virus’ isolated from a patient with chronic fatigue syndrome. Clin Diag Virol 1995: 4: 93-103.

20 Martin W J. Stealth viruses as neuropathogens. CAP Today. 1994; 8: 67-70.

21 Martin W J. et al. Cytomegalovirus-related sequence in an atypical cytopathic virus repeatedly isolated from a patient with chronic fatigue syndrome. Am J Pathol. 1994; 145: 440-51.

Discovery of Low Density/High Energy Water and High Density/Low Energy Water

Wiggins P M. High and low density water in gels. Prog Polymer Sei. 1995; 20:1121.

Wiggins P. High and low density water and resting, active and transformed cells.

Cell Biol Internat. 1996; 20:429-435.

Wiggins P. Life depends upon two kinds of water PLoS 2008; 3:e1406.

Wiggins P. High and low density intracellular water. Cell Mol Biol. 2001; 47:735-44.

Medicinal Benefits of Moderate Consumption of Alcohol

http://www2.potsdam.edu/hansondj/AlcoholAndHealth.html (Extensive bibliography) http://rosemelnickmuseum.wordpress.com/2010/04/07/medicinal-alcohol-and-prohibition/STATEMENT

### REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

In a recently submitted co-pending patent application, which is incorporated by reference herein, I disclosed that the passage of electrolytically derived “Water Gas” into absolute alcohol greatly enhances the ability of the alcohol to react with neutral red dye and with alternative cellular energy (ACE) pigments. When particles of neutral red dye are added to Water Gas “charged” alcohol and the mixtures is examined microscopically, there is rapid and vigorous dissolving of much of the neutral red dye, which occurs in a directional manner forming long, narrow red streams of dissolved neutral red dye. Equally impressive, the light from the microscope causes fine particles of neutral red that remain non-dissolved to undergo rapid to-and-fro movements in relationship to focal areas developing within the fluid, with apparent attractive forces rapidly alternating with repulsive forces. The neutral red dye containing charged alcohol solutions are also more fluorescent under ultraviolet (UV) light illumination. The linearity of the dissolving neutral red, the dynamic oscillatory movements of non-dissolved particles and UV inducible fluorescence also occur in regular (non-charged) absolute alcohol, but are greatly heightened by Water Gas charging of the alcohol. The charged alcohol also shows greater interaction than does non-charged alcohol with ACE pigments collected from the saliva of stealth adapted virus infected patients. When used therapeutically, the charged alcohol was sensed as being more effective than was untreated (non-charged) alcohol, when sequentially used with neutral red dye and illuminated with UV light, in a previously described manner, which is able to activate the ACE pathway in an ACE deficient individual.

Water Gas infused (charged) Lidocaine plus herbal formulations, as well as charged water and other liquids, were similarly found to be more dynamic in their interaction with neutral red dye and with ACE pigments, when compared to untreated (non-charged) control liquids. It was proposed that by combining charged alcohol and charged water in various combinations or by using each liquid alone, would provide a range of solutions for various therapeutic applications. The applications include procedures, which do not require the direct contact of the charged solutions with the skin and/or mucus membranes. The charged solutions can also potentially be used for direct topical application to the skin and for parental injections or consumption, with or without the inclusion of neutral red dye and/or ACE pigments. The purpose of the present patent application is to extend the observation to include various alcoholic beverages. The benefit of these additional observations is that it can help simplify home-based therapies aimed at enhancing the ACE pathway in humans and animals. It may also help revive interest in the medicinal uses of consuming Water Gas charged alcoholic beverages, and in devising alternative methods of charging alcoholic beverages to enhance their therapeutic usefulness.

### BRIEF SUMMARY OF THE INVENTION

Water gas can be generated electronically by placing electrodes connected to a direct current generator into water, which contains sufficient electrolytes to allow the direct current to pass between the electrodes. Water gas is different from either the hydrogen or oxygen gases, which are generated at the cathode and anode electrodes, respectively, and also different from a simple mixture of these two gasses. Rather, it is presumed that the water gas is derived from electronically energized water. It is further presumed that the water gas can transfer some of its energy back into regular water. I have previously shown that water gas can transfer its energy into other liquids, including absolute alcohol. The present extension of these ongoing studies is the finding that water gas can also add considerable energy to alcoholic beverages. Specifically, I have found that the passage of electrolytically derived Water Gas into alcoholic beverages greatly enhances the ability of the beverage to react with neutral red dye, as shown by i) much more rapid and extensive linear streaming of the dissolving neutral red dye. ii) The appearance of more dynamic foci within the fluid, from which small non-dissolved dye particles can be seen undergoing, light induced, rapid to-and-fro movements, commonly beginning in a non-concentric pattern. iii) Enhanced fluorescence of the neutral red solution to UV illumination. These observations are consistent with the charged alcoholic beverages having an enhanced ACE pathway activating potential, compared to the corresponding alcoholic beverage, which has not been charged with Water Gas.

### BRIEF DESCRIPTION OF THE DRAWINGS

Not Applicable and none included

### DETAILED DESCRIPTION OF THE INVENTION

Until recently, UV light illuminated neutral red dissolved in regular absolute alcohol (200 proof ethanol) has been the preferred method of choice for systemically activating the ACE pathway in an individual. Approximately 5 mg of neutral red freshly dissolved in 10 ml of alcohol has generally been placed in a re-sealable plastic bag (Ziploc) with a small sheet of absorbent paper to help evenly distribute the fluid. The plastic bag is placed onto a moistened surface of the body to help minimize intervening air pockets, with taping as necessary. Preferred sites for placing the bags are the soles of the feet, palms of the hand and the face. The bag is usually illuminated with a 13 Watt spiral ultraviolet light bulb (Halco) positioned closely to the solution. In some experiments two 40 watts, 4 feet long tubular UV bulbs have been used. The illuminated solution shows a yellow-orange fluorescence in a darkened room. The therapy session will typically last from 30-60 minutes. Before, during and after the procedure, the treated area and the oral cavity are examined for using the same type of Halco UV light, or a more focused UV Streamlight 365 nm LED penlight. In an ACE deficient individual, one would expect to see the development of oral fluorescence as an indication of systemic activation of the ACE pathway. If no inducible fluorescence occurs within the oral cavity or elsewhere on the body, a tentative conclusion can be that there is unlikely to be a deficiency of the ACE pathway, which is correctable using this procedure.

This basic method was improved when I pretreated the alcohol being used with electronically generated Water Gas. Initially, I produced Water Gas by electrolysis of a 5 liter solution of citric acid and potassium carbonate (30 grams of each/1 with pH adjusted to 5.5). A 4-5 amp current was provided by a Sears DieHard battery charger, using pure copper electrodes. A plastic inverted funnel 4″ wide with attached flexible tubing was held just slightly above the surface of the solution. The funnel was placed between and away from the two electrodes, in order to somewhat minimizes the collection of the hydrogen and oxygen gases coming directly from the electrodes. The other end of the flexible tubing from the funnel was attached to a 240 ml suction canister containing 200 ml alcohol with the inlet tube being inserted well down below the surface of the alcohol. The narrow outlet tube from the suction canister was connected to a vacuum pump. The vacuum driven system was effective in bringing any Water Gas released from the electrolysis reaction, along with electrode generated gases and normal air entering from the sides of the collecting funnel, into the alcohol solution. Electrolysis and gentle vacuum suctioning proceeded for 2-4 hours. The Water Gas treated alcohol was much more interactive with neutral red dye and with ACE particles, then untreated alcohol or alcohol through which only air had been passed.

A similar series of experiments with confirmatory results was performed using a small, internet-available, Brown's Gas, or what I prefer to call “Water Gas” generator (watertogas.com). The device, similar to that described in Patent Application 2010/0147232 “System and Method for Improving Fuel Economy in Combustion Engines,” was obtained from Mr. Bill Lang, one of the authors on the patent application. The basic unit is a 500 ml water bottle with electrodes extending down from two insulated holes placed into the plastic lid. Sodium bicarbonate (1 teaspoon or approximately 3.5 gm) is added to approximately 350 ml of tap water to render it electrically conductive. As an alternative diluted sea water can be used or the citrate:potassium carbonate solution referred to earlier. Connecting the leads from a 4.5 DC 300 mA transformer to the electrodes produces electrolysis and gas formation in this electrolyzer unit. The stem of a “T” shaped tubing connection piece passes into the sealed jar. One of the horizontal arms of the “T” shaped connecting piece receives air provided by a small aquarium pump. The other horizontal arm of the “T” shaped connection piece is connected to a tube, which is used to supply the Water Gas to a test liquid. A potential benefit of the inverted funnel device connected to a vacuum line is that it somewhat minimize the collection of hydrogen and oxygen gases coming directly from the electrodes. The closed jar system—positive flow method, which collects all of the gases being produced (hydrogen, oxygen and Water Gas) proved satisfactory and was considered to be more practical and convenient for household use. Moreover, many similar units are currently being marketed over the internet to enhance fuel economy on automobiles. Similar electrolyzer units are also available as ionic footbaths for presumed detoxification.

A range of alcoholic beverages was tested for their interaction with neutral red dye, both before and after the infusion of Water Gas. Examples included, Bombay Sapphire Gin (47% alcohol); Skyy vodka (40% alcohol); Paul Mason VSOP Brandy Grande Amber (40% alcohol); Marker's Mark Whisky (45% alcohol); Pernod (40% alcohol); Sandyman Ruby Port (19.5% alcohol); Penfold Bin 128 Shiraz 2006 (14.5% alcohol); Kendall Jackson Sauvignon Blanc 2008 (13.5% alcohol); and Foster's beer (assumed to be about 4% alcohol). Initially, I had used several hours of Water Gas infusion to charge absolute alcohol solutions but this led to a major reduction in the relative concentration of alcohol in the alcoholic beverages through evaporation. I subsequently observed that even 15-30 minutes would produce clearly discernable changes in each of the alcoholic beverages studied, with very little actual loss of alcohol content.

The basic testing was to compare the reactivity of the charged alcoholic beverage with neutral red with the reactivity of the same beverage, which had not been charged. The reactivity was observed microscopically in either small individual plastic dishes or in the wells of multi-welled plastic trays. It was observed that 15-30 minutes infusion of the Water Gas through the alcoholic beverages clearly enhanced their capacity to dynamically interact with particles of neutral red dye. Among the microscopic changes seen were more rapid dissolving of most of the neutral red particles, with more sharply defined and strikingly long narrow streams of dye coming from individual particles. Remaining small un-dissolved neutral red particles displayed pronounced and persisting back and forth (to-and-fro) movements, which were more marked than seen with the same beverage, which had not been charged. Microscopically one could more easily observe individual particles moving towards each other to form a small clump of particles, but then to abruptly reverse direction and re-separate, only to again be re-attracted to each other and reform into a clump. Some particles stayed within the clumps while others displayed the to-and-fro movements. Occasionally, a small clump of previously stationary particles would shoot off one or more particle, or the entire group would instantly disperse. A final measure of the difference between charged alcoholic beverages and their corresponding controls was the intensity of the fluorescence of the neutral red containing solution when illuminated with a Halco 13 watt spiral UV light.

The different alcoholic beverages varied widely in their inherent reactivity with neutral red dye. Of the beverages listed above, vodka displayed the more pronounced kinetic activity of non-dissolved particles; Pernod showed the greatest UV fluorescence. Charging with Water Gas markedly enhanced each activity. While very little activity was shown by untreated port, wine or beer, weak but still discernable activity occurred after “Water Gas” charging of these three beverages. Brandy was more active than gin in both non-charged and charged states.

The charged vodka, brandy and whisky liquids have provided fresh insights into the energy transduction process occurring in the charged solutions. By using other particulate materials, such as fine graphite powder, I could document what appeared to be internal narrow steams of fluid movements, which can carry individual particles over considerable distances. The dynamic movements of the non-dissolved neutral red particles, however, were in excess of those seen with graphite, suggesting that these particles were being energized. Much of the energy transfer appeared to be from focal areas developing within the light illuminated liquid, with reciprocating attraction and repulsion forces. The larger particles would typically rotate 180° as they reverse direction. The enhanced kinetic movements were retained as long as the samples were being illuminated and ceased when held away from the light. While heat (thermal energy) may be a small contributing factor, movements were clearly inducible using light emitting diode (LED) provided lighting. The inflow and expulsion process of the liquid was also considered as possibly being driven by pressure forces, as can be observed in oscillating bubbles caused by gas discharges within a liquid. Whatever, the mechanism, it is clear that Water Gas can be used to increase the energy levels of alcoholic beverages, and by extension, improved the ability of the beverage to mediate ACE pathway activation.

The finding that different types of alcoholic beverages of the same alcohol concentration can show differing baseline levels of neutral red kinetic activity, strongly implies that the additional ingredients or methods of production can also influence the energy absorbing and energy transducing activities of the beverage. These considerations also point to a possible explanation of the efficacy of some forms of homeopathy.

Alcoholic beverages have historically been regarded as having possible medicinal and longevity benefits. Indeed, large population studies have confirmed significant reductions in many types of illnesses among those who consume moderate quantities of alcohol on a daily basis compared to teetotalers. The diseases include the prevention of heart attacks, strokes, type 2 diabetes, senile dementia, Parkinson's disease, rheumatoid and osteoarthritis, osteoporosis, certain forms of cancer, etc. Alcohol containing formulations were commonly prescribed in the early 1900's as a general tonic as well as specific therapy for diseases, such as hypertension, anemia, typhoid, and tuberculosis. It was also noted that beer, wines and spirits all share the apparent medicinal benefits, although to different extents. The apparent medicinal benefits of alcoholic beverages have traditionally been attributed to other components within the beverage, e.g., terpenes leached from wooden casks, antioxidants, specific chemicals, such as resveratrol in red wines, trace minerals, and others. Similarly, the wound healing benefits attributed to alcohol are generally solely ascribed to its anti-bacterial actions.

My working model is that the neutral red activating quality of alcoholic beverages more likely reflects and correlates with their inherent ability to activate ACE pigments; and that charged alcohol from the more highly active beverages, can reasonably be included within the term enerceutical™. The Water Gas infusion method provides a relatively long lasting (beyond a week) effect on the alcoholic beverages. There is already a suggestion that repeated jolting (termed succussion when applied to homeopathic solutions) of a much longer stored, previously charged alcoholic beverage, may add to (and revive) its capacity to transfer kinetic energy to neutral red dye and by inference to the body's ACE pathway.

The principles, preferred embodiments and modes of operation of the present invention have been described in the foregoing specification. The invention, intended to be protected herein, is not to be construed as limited to the particular method of charging alcoholic beverages. I clearly understand now that electrolysis-generated water gas is one of several energy driven processes that may also be able to similarly charge alcoholic beverages. One alternative would be to use an electrolyzer to directly treat the alcoholic beverage, with the required addition of sufficient electrolytes to allow for current flow. A drawback of this approach is the release of metal from most types of electrodes into the alcoholic beverage. More interesting direct approaches to treating the alcoholic beverage can be inferred from various methods used to enhance the plant growth and possible human health promoting activity of treated water. Such methods include vortexing, exposure to static or more commonly variable magnetic fields, pulsations with electromagnetic and/or sound energies, addition of infrared and or negative ions emitting materials, such as germanium, tourmaline and silicates, use of humates and/or zeolites, etc. The important principle is that the approaches being used to enhance water quality can potentially be extended to alcoholic beverages.

Of considerable benefit in all such endeavors is the simplicity of the neutral red kinetic activity and UV inducible fluorescence assays, applied to alcoholic beverages. The patent application is not restricted to the use of neutral red as the indicator dye, since other dyes can and has been used in similar experiments, e.g. acridine orange. Nor is the term “charging” meant to be exclusive of other relevant terms, which other investigators may wish to use in furthering the research described in this application. For example, I could have easily used the term “energized” alcoholic beverages. The major attribute of interest is an enhanced ability of alcoholic beverages to function effectively within the ACE pathway, and in particular to help energized this pathway in individuals who would thereby receive health or performance benefits. An immediate application of the present discovery is the advice provided to a parent of an autistic child to test Water Gas infused vodka and Pernod solutions, with added neutral red dye, in place of Water Gas infused absolute alcohol with neutral red dye. Alcoholic beverage companies will also be advised of the findings to determine their interest in adding a Water Gas activation step in the manufacturing of their products. If not, then the final consumer may be able to charge their alcoholic beverage, after it is purchased and prior to it being consumed. The inventor realizes the many far-reaching consequences of redefining the medical benefits of moderate consumption of alcoholic beverages, especially those that are charged using the method described in this application. The application is also intended to cover alternative methods aimed at achieving the same goal of enhancing the enerceutical™ quality of alcoholic beverages and for uses and applications other than oral consumption. Additional modifications of the basic tenets disclosed in the present patent application will readily occur to those skilled in the art and especially upon practicing the currently described methods. Therefore, many variations and changes may be made without departing from the scope and spirit of the invention as encompassed by the appended claims.

1. A method for assessing the relative alternative cellular energy (ACE) pathway activating potential of an alcoholic beverage, comprising the addition of a limited number of dispersed neutral red particles to the alcoholic beverage and microscopically observing the particles for the following characteristics: i) the rate of dissolving of most of the particles, and the formation and lengths of linear streams of the dissolving neutral red dye coming from individual particles; ii) the extent, speed and asymmetry within the beverage fluid, of kinetic movements by the neutral red particles which remain un-dissolved, including the continuing to-and-fro movements of individual particles in relationship to a clearly observed focal point, which may contain more-stationary collections of other un-dissolved particles; iii) the intensity of ultraviolet light induced fluorescence of the neutral red dye containing alcoholic beverage; such that an aggregate measure of these three observable characteristics, provide direct positive indicators for assessing the relative level of ACE pathway activating potential of various alcoholic beverages.

2. A method for “charging” an alcoholic beverage, as a means of enhancing its alternative cellular energy (ACE) pathway activating potential; comprising the electrolytic generation of “water gas,” (otherwise known as Brown's Gas or HHO), which is passed into the alcoholic beverage to be charged, for a sufficient period of time and in a sufficient quantity, for the alcoholic beverage to show a different type and/or intensity of interaction with particles of added neutral red dye, compared to that seen when a similar quantity of neutral red particles is added to the same alcoholic beverage which has not been charged; the most noticeable differences in interaction being i) more rapid dissolving of many of the particles, with longer linear streams of dissolved neutral red dye coming from individual particles; ii) more rapid, more extensive and asymmetric patterns of movements of neutral red particles which remain un-dissolved, including the continuing to-and-fro movements of some individual particles in relationship to clearly observed focal points, which may contain more-stationary collections of other particles; iii) more intense ultraviolet light induced fluorescence of the neutral red dye containing charged alcoholic beverage; these changes comprising direct positive indicators that the charged alcoholic beverage has an increased capacity, when compared to the same alcoholic beverage in the uncharged form, for activating the alternative cellular energy (ACE) pathway of an individual.

3. A method for assessing the ability of a procedure to enhance the alternative cellular energy (ACE) pathway activating potential of an alcoholic beverage comprising the addition of a limited number of dispersed neutral red particles to the alcoholic beverage, before and after the procedure, and microscopically observing the particles in order to record changes in the following characteristics: i) the rate of dissolving of most of the particles, and the lengths of linear streams of the dissolved neutral red dye coming from individual particles; ii) the extent, speed and asymmetry within the liquid of kinetic movements of neutral red particles which remain un-dissolved, including the continuing to-and-fro movements of some individual particles in relationship to a clearly observed focal point, which may contain a more stationary collections of other particles; iii) the intensity of ultraviolet light induced fluorescence of the neutral red dye containing alcoholic beverage; such that an increase in one or more of these observable characteristics is an indication that the procedure is effective in enhancing the alternative cellular energy (ACE) activating potential of an alcoholic beverage.

4. The method of claim 3 in which the procedure includes the use of electromagnetic, electrical, magnetic or sound energies for rendering the alcoholic beverage more dynamically interactive with neutral red dye, and by inference more capable of activating the alternative cellular energy (ACE) pathway of an individual

5. The method of claim 3 in which the procedure includes the use of negative ions emitting materials, such as germanium, tourmaline, humic acids and/or zeolites, for rendering the alcoholic beverage more dynamically interactive with neutral red dye, and by inference more capable of activating the alternative cellular energy (ACE) pathway of an individual

6. The method of claim 2 in which the method of charging the alcoholic beverage is employed during the manufacturing of the alcoholic beverage.

7. The method of claim 2 in which the method of charging the alcoholic beverage is employed by a purchaser of an alcoholic beverage prior to its being utilized as a drink or used in other ways intended to enhance the alternative cellular energy (ACE) pathway of an individual, including placing the charged alcoholic beverage to which neutral red dye has been added, in close proximity or in direct contact with the body and illuminating the solution with an ultraviolet light for sufficient time to induce skin and/or oral cavity fluorescence in an ACE deficient individual.

8. The method of claim 2 in which the alcoholic beverage includes any of the following: beer, wine, port, whiskey, brandy, gin, vodka and Pernod.
